(19) United States
(12) Patent Application Publication
(10) Pub. No.: US 2026/0202339 A1
(43) Pub. Date: Jul. 16, 2026

(54) HIGHLY REPRODUCIBLE UNIFORM RING ARRAYS FOR QUANTITATIVE SURFACE ENHANCED RAMAN SPECTROSCOPIC DETECTION

(71) Applicant: The Governors of the University of Alberta, Edmonton (CA)

(72) Inventor: Xuehua Zhang, Edmonton (CA)

(73) Assignee: The Governors of the University of Alberta, Edmonton, AB (CA)

(21) Appl. No.: 19/137,332

(22) PCT Filed: Dec. 14, 2023
(86) PCT No.: PCT/CA2023/051660

§ 371 Date: Jun. 10, 2025

Related U.S. Application Data
(60) Provisional application No. 63/432,508, filed on Dec. 14, 2022.

(51) Int. Cl. G01N 21/65; B82Y 30/00; B82Y 40/00

(52) U.S. Cl. CPC G01N 21/658; B82Y 30/00; B82Y 40/00

(57) ABSTRACT

A surface-enhanced Raman spectroscopy (SERS) having a plurality of ordered nanostructures arranged on a substrate and a process of making the same are provided. The process of fabricating silver nanoparticles from surface nanodroplet reaction includes placing a chemically micro-patterned substrate inside a narrow fluid chamber; filling the chamber with a ternary mixture; replacing the ternary mixture by water saturated with Vitamin E to form droplets of Vitamin E (VE) on the substrate with hydrophobic micro-patterns; providing a precursor solution to the substrate by passing the precursor solution through the microchamber; providing VE droplet liquid on the micro-patterned substrate; and reacting the precursor solution with the VE droplet liquid at a biphasic interface of the droplets on the substrate leading to the nucleation of AgNPs and subsequent growth towards nanostructures.

### RELATED APPLICATIONS

This application claims priority benefit of U.S. Provisional Application Ser. No. 63/432,508 filed 14 Dec. 2022; the contents of which are hereby incorporated by reference.

### FIELD OF THE INVENTION

The present invention relates to substrates for, surface-enhanced Raman spectroscopy (SERS) and a method for making that same, and more particularly to an easy and efficient strategy for the fabrication of surface-bound nanostructures, overcoming the problems of reproducibility and quantitative detection by SERS.

### BACKGROUND OF THE INVENTION

Ultrasensitive detection of target analytes is of fundamental importance in various fields of analytical science and technology such as monitoring of pollutants,¹ screening of explosives,² toxicity of biological species,³ and detection of illicit drugs.⁴ Among a variety of analytical methods, surface-enhanced Raman spectroscopy (SERS) is a widely used strategy to enhance the Raman signal based on their interaction with the electromagnetic fields generated by the excitation of localized surface plasmons on the metallic nano-structures.^{3,5,6} In addition to the analyte concentration, the reliability and the reproducibility of the SERS signal acquisition is influenced by the type of nanoplasmon used and the morphology of the substrate as they will directly affect the SPR and molecular adsorption of the SERS substrate.^{7,8} SERS can be combined with a pre-concentrate processes such as extraction and⁹ evaporation¹⁰ to boost sensitivity.¹¹ Development of an effective approach for the fabrication of SERS substrate, that enables in situ quantitative detection of molecular fingerprint with great sensitivity and reproducibility still remains challenging.

One of the main reasons for low reproducibility of SERS is uneven distribution of nanostructures on the substrate.¹² The difference in number of intrinsic hotspots (areas within the plasmonic nanostructures where the optical field is greatly amplified relative to their surroundings) per particle results in unstable Raman signals during measurement.¹³ To overcome this uncertainty, ordered structures have been used to improve the reproducibility of SERS by fixing certain hotspots of each scan.¹⁴⁻²⁰ Some approaches, such as self-assembly,^{21,22} template,^{23,24} and electron beam lithography,²⁵ have been applied to fabricate regular pattern/s of nanofilms,²⁶ nanorods,¹⁹ and nanodots.¹⁷

For example, Xu et al.²⁷ fabricated an ordered SERS substrate that can achieve the detection of a typical analyte molecule, rhodamine 6G (R6G) with a limit of detection (LoD) of 10⁻¹¹M and a quantification range from 10⁻⁸-10⁻¹¹M. Wang et al.²⁶ fabricated electrochemically roughened nano-Au film SERS substrate that can achieve the detection of R6G with a LoD of 10⁻¹¹ M and a quantification range from 10⁻⁵-10⁻⁹ M. Zhang et al.²⁸ fabricated micro/nano-hierarchical structures of rose petals as SERS substrate that can achieve the detection of R6G with a LoD of 10⁻¹⁰ M and a quantification range from 10⁻⁵-10⁻¹⁰ M. However, fabrication of nanostructures with high precision dimensions requires sophisticated equipment and a dedicated clean room.

Li et al. 9 studied nano-extraction based SERS detection by using surface nanodroplets and achieved an LoD of 10⁻⁹ M with a range of quantitative detection from 10⁻⁶-10⁻⁹ M using R6G. Ag functionalized binary surface nanodroplets of vitamin E (VE) and octanol were produced on a homogeneous substrate to achieve the extraction and detection of the chemicals by SERS. Surface nanodroplets are the nanoscale (in height) droplets immobilized on a solid substrate surrounded by an immiscible liquid.²⁹ These surface nanodroplets are capable of extracting the analytes from an external flow and the microchamber acts as a biphasic reactor allowing the biphasic reactions between the surface nanodroplet and the reactants in the external flow.³⁰ Bao et al.³¹ formed a regular array of surface nanodroplet array by using chemically pre-patterned Si substrate. Recently, Wei et al.³² demonstrated the fabrication of surface-bound metal oxide nanocaps with tunable size and porosity from surface nanodroplets via biphasic reaction of droplet liquid and metal salts precursor solution.

However, simple, cost-effective, and solution-based approaches are still needed for the fabrication of uniform structured substrates for the widespread applications of SERS. Furthermore, there exists a need for ordered metallic nanostructures acting as SERS substrates with high reproducibility and high sensitivity.

### SUMMARY OF THE INVENTION

The present invention provides a surface-enhanced Raman spectroscopy (SERS) having a plurality of ordered nanostructures arranged on a substrate and a process of making the same. The process of fabricating silver nanoparticles from surface nanodroplet reaction includes placing a chemically micro-patterned substrate inside a narrow fluid chamber; filling the chamber with a ternary mixture; replacing the ternary mixture by water saturated with Vitamin E to form droplets of Vitamin E (VE) on the substrate with hydrophobic micro-patterns; providing a precursor solution to the substrate by passing the precursor solution through the microchamber; providing VE droplet liquid on the micro-patterned substrate; and reacting the precursor solution with the VE droplet liquid at a biphasic interface of the droplets on the substrate leading to the nucleation of AgNPs and subsequent growth towards nanostructures.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A is an illustration of VE droplet formation on a patterned hydrophobic and hydrophilic substrate using solvent exchange process according to embodiments of the present invention;

FIG. 1B is an illustration of the formation of ring array of AgNPs functionalized surface droplets as a result of the biphasic reaction between the VE droplet and the AgNO3 precursor solution according to embodiments of the present invention;

FIG. 1C is an illustration of selection of analytes on Ag nanostructures using confocal Raman spectroscopy according to embodiments of the present invention;

FIG. 2 is an illustration showing biphasic reaction between Vitamin E (VE) surface droplet and AgNO₃ precursor solution according to embodiments of the present invention;

FIG. 3 shows a biphasic reaction scheme at the interface of the VE droplets with the Ag⁺ ions in the alkaline medium to produce AgNPs according to embodiments of the present invention;

FIG. 4A shows an optical image of Ag nanostructures formed at 2.0 mM AgNO₃ at pH 10 (structure S1);

FIG. 4B shows an optical image of Ag nanostructures formed at 0.5 mM AgNO₃ at pH 10 (structure S2);

FIG. 4C shown a SEM image of structure S1 showing uniform nanostructures with dendritic morphology;

FIG. 4D shows a SEM image of structure S2 showing uniform nanostructures with sheet-like morphology

FIG. 4E shows an EDX spectrum indicating the formation of silver;

FIG. 5A shows an optical image of SERS substrate before flushing with Milli-Q water;

FIG. 5B optical image of SERS substrate after flushing with Milli-Q water;

FIG. 5C shows an optical image of Ag nanostructured rings on the SERS substrate fabricated using large chamber;

FIG. 5D shown an image showing the fabricated SERS substrate over a large area of 80 mm×60 mm;

FIG. 5E shows an optical image of Ag nanostructured rings on a large SERS substrate fabricated using a large chamber;

FIG. 6A shows one of the repeated SERS measurements of R6G using structure S1; FIG. 6B shows SERS spectra of R6G using structure S1;

FIG. 6C shows SERS spectra of R6G using structure S2

FIG. 7A shows one of the repeated SERS measurements of TC using structure S1;

FIG. 7B shows SERS spectra of TC using structure S1;

FIG. 7C SERS spectra of TC using structure S2;

FIG. 8A shows one of the repeated SERS measurements of CP using structure S1;

FIG. 8B shows SERS spectra of CP using structure S1;

FIG. 8C shows SERS spectra of CP using structure S2;

FIG. 9 shows the SERS spectra of IS using structure S1;

FIG. 10A shows a study of the evolution of dendritic Ag nanostructures on the patterned Si substrate with FESEM images of the Ag structures formed on the substrate after 15 min;

FIG. 10B shows a study of the evolution of dendritic Ag nanostructures on the patterned Si substrate with FESEM images of the Ag structures formed on the substrate after 30 min;

FIG. 10C shows a study of the evolution of dendritic Ag nanostructures on the patterned Si substrate with FESEM images of the Ag structures formed on the substrate after 90 min;

FIG. 10D shows a study of the evolution of dendritic Ag nanostructures on the patterned Si substrate with FESEM images of the Ag structures formed on the substrate after 3 h;

FIG. 10E shows a study of the evolution of dendritic Ag nanostructures on the patterned Si substrate with FESEM images of the Ag structures formed on the substrate after 5 h;

FIG. 10F shows a study of the evolution of dendritic Ag nanostructures on the patterned Si substrate with FESEM images of the Ag structures formed on the substrate after 7 h;

FIG. 10G shows a plot representing the average increase in length of the dendritic structure with increase in time;

FIG. 10H shows a schematic illustration of the growth process of dendritic Ag structures;

FIG. 11 shows the Raman spectra of the R6G at the LoD concentrations using different Ag nanostructures. S1-S8 are the Ag structures listed in Table 1;

FIG. 12 shows Raman spectra of IS in PBS buffer, compared to that of blank Si substrate, and PBS buffer on Si substrate;

FIG. 13A shows an optical image taken from Confocal Raman while mapping Ag nanoparticles on PDMS with microwell structures;

FIGS. 13B-13D are 2D live mapping images at different peaks of the same optical region shown in FIG. 13A;

FIG. 13E is a combination of R6G spectra from 100 different locations on the microwell substrate;

FIG. 13F shows peaks 610, 1360, and 1510 from FIG. 13E and the relative standard derivation (RSD) of approximately 200 spectra obtained from mapping of R6G;

FIGS. 14A-14C show the images of the Ag nanoparticles on plain PDMS; and

FIGS. 14D-14G show Raman mapping of R6G at the concentration of 108 M, and the relative standard derivation of the signal intensity.

### DESCRIPTION OF THE INVENTION

The present invention has utility as a simple, cost-effective uniform structured substrate for the widespread applications of SERS, and more particularly as ordered metallic nanostructures acting as SERS substrates with high reproducibility and high sensitivity and a method for producing the same. Embodiments of the present invention use a droplet-based biphasic reaction, which is an easy and efficient strategy for the fabrication of surface-bound nanostructures, overcoming the problems of reproducibility and quantitative detection by surface enhanced Raman spectroscopy (SERS). According to embodiments, the process of fabricating ordered micro-ring arrays of silver nanostructures from surface nanodroplet reaction on a micro-patterned hydrophobic substrate immersed inside a microfluidic chamber is used. The continuous flow of AgNO₃ precursor solution reacts with the Vitamin E (VE) droplet liquid at the biphasic interface leading to the nucleation of AgNPs and subsequent growth towards Ag nanostructures at the three-phase contact line. The SERS activity of Ag nanostructures fabricated at 8 different operating conditions are compared, varying the initial concentration of the precursor solution and pH of the reacting medium. Good reproducibility from 4-5 substrates is obtained by using the droplet-reaction approach, as both the steps of droplet generation and Ag nanostructures formation are of good reproducibility. The entire process is solution based and is finely tuned by controlling the flow rate, precursor concentration, and reaction time. By increasing the size of the microchamber, SERS substrates in batches of up to 100 in a single run are produced, demonstrating the scalability of the inventive method. The fabricated Ag nanostructures are stable to the flow. Furthermore, the quantitative detection and repeatability of SERS measurements using Ag nanostructures by analyzing three environmental (rhodamine 6G (R6G), chlorpyrifos (CP), triclosan (TC)) and a biological model compound (indoxyl sulfate (IS)) is demonstrated. A minimum relative standard deviation (RSD) of 3.2% is achieved using synthesized nanostructures, which corresponds to very high reproducibility. Four repeats of the experiment are performed with <0.1% deviation, where the data is collected from five different locations in each experiment. The in-situ study provides a simple droplet-based biphasic reaction methodology for the fabrication of SERS substrate addressing the current challenges of reproducibility and quantification in SERS measurements.

Surface nanodroplets demonstrate the ability to fabricate ordered micro/nanostructures bound to a substrate. Herein, an approach for the synthesis of ordered nano/micro-ring arrays of SERS active Ag nanostructures from the biphasic reactions at the interface of the immobilized surface nanodroplets is demonstrated. The reactions are performed using non-toxic solvents via a simple solvent exchange pathway which makes this a green synthesis. Using these Ag nanostructures, three environmental model compounds and one model compound relevant to health are analyzed. Reproducibility is obtained with a relative standard deviation (RSD) of ~3.2% and ~4.3% by using sheet-like and dendritic structures.

The flow controlled solvent exchange approach for the fabrication of Ag nanostructures, provides good reproducibility of SERS measurements. As the whole process is solution based, parameters such as flow rate, droplet volume, precursor concentration, and pH of the reaction medium are well controlled to maintain the uniformity of the structures throughout the substrate. The whole process, involving generation of uniform sized VE droplets, followed by droplet reaction responsible for generation of uniform Ag nanostructures, and the final step of supplying analyte for SERS detection are well controlled. Moreover, the fabricated substrate is of one-use and does not show any memory effect of the previous sample solutions, which is also responsible for good reproducibility.

The surface nanodroplets generated by this solvent exchange approach are highly uniform in size, immobile, and are stable with time even in the presence of continuous flow. This opens up the possibility of occurrence of reactions with high residence time and also provides the feasibility of refreshing the reactant at the droplet surface by continuous supply of the reactant into the reaction chamber. Furthermore, the continuous flow of EtOH helps in displacing the soluble reaction product VEq from the hydrophobic microdomain towards the outlet of the microchamber. The demonstrated methodology for the fabrication of SERS substrate and detection of target model compounds is reproducible and provides a promising technique for ultrasensitive analysis of many model compounds, such as environmental pollutants, screening of explosives, toxicity of biological samples, detection of illicit drugs, or hormones in regular body fluids.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

According to embodiments, the following chemicals are used as supplied, without further purification: Ethanol (EtOH, 90%), silver nitrate solution (AgNO₃, 0.1 N), sodium hydroxide (NaOH, 98%), 1-octanol (99%), and rhodamine 6G (R6G, pure) from Fisher Scientific. DL-α-tocopherol (Vitamin E (VE), 97%) from Alfa Aesar, octadecyl trichlorosilane (OTS, 95%) from Acros Organics, chlorpyrifos (CP) from Sigma Aldrich, triclosan (TC, 98%) from TCI Chemicals, and silicon wafer (Si-wafer) from University wafer, USA. Water purified from Milli-Q water purification unit (Millipore Corporation, Boston, MA, USA) is used in all the experiments.

### Fabrication of Hydrophobic Microdomains on Hydrophilic Substrate

In the first step, the bare hydrophilic Si-wafer is pre-treated by sonicating with Milli-Q water, followed by EtOH for 20 min each. In the next step, the Si-wafer is immersed into piranha solution [H₂SO₄(70%): H₂O₂(30%)] using a hot plate at 75° C. for 20 min, and is further sonicated using Milli-Q water for 10 min. The Si wafer is placed inside the hot air oven for 1.5 h, before it is coated with OTS by following the protocol reported in previous work.³³ In brief, Si wafer is immersed in 0.5 vol % OTS dissolved in hexane for ~12 h in a sealed container at room temperature. Then, the OTS-coated Si wafer is cleaned using hexane, followed by ethanol, and is stored in a clean container for further use.

In the last step, patterns of hydrophobic microdomains are created on the OTS-coated Si wafer using photo-lithography method reported in the literature.³⁴In brief, the OTS-coated Si wafer is spun coated with photoresist (AZ 1512) and a photo mask is placed on the substrate. During the process of photolithography, the hydrophobicity of the microdomains is protected by the photoresist, while the exposed areas are etched with plasma. Finally, after complete cleaning of the photoresist, an alternate pattern of hydrophobic domains with 5.0 μm in diameter adjacent to a hydrophilic spacing of 2.0 μm is obtained.

### Formation of Uniform Surface Nanodroplet Arrays

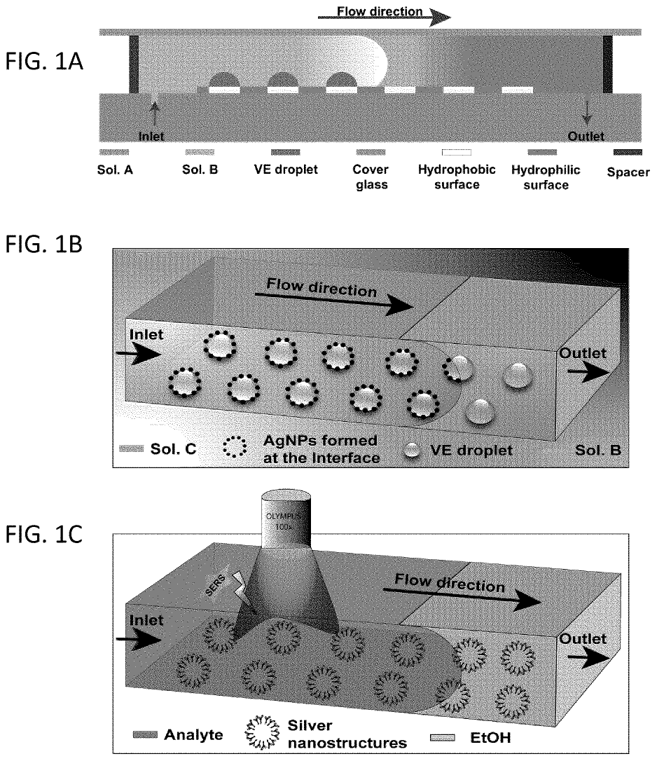

Surface nanodroplets of VE are generated on the surface of the chemically patterned hydrophobic/hydrophilic Si substrate via solvent exchange process as shown in FIG. 1A.³⁵ The dimensions of the microfluidic chamber are 54 mm in length (inlet to outlet), 11 mm in width (inlet & outlet), and 0.5 mm in height (distance from surface of the substrate and the bottom of the cover glass). During the process of solvent exchange, a good solvent of VE droplet (e.g., EtOH) is displaced by a poor solvent (e.g., water saturated with octanol), such that the oversaturated VE liquid precipitates to from droplets of VE on the patterned substrate. Droplet generation during the solvent exchange process is due to heterogeneous nucleation, followed by a diffusive growth.

Initially, the microchamber with patterned substrate is filled with a ternary mixture (sol.A) comprising of water, ethanol, and VE with a volume ratio of 10:90:2.2. In the next step, sol.A is replaced by water saturated with octanol (sol.B) at a constant flow rate of 5 mL/h to form droplets of VE. The top cover glass of the microchamber is a transparent quartz slide, allowing the visualization of surface droplets formed on the patterned substrate. The optical images of array of VE droplets formed on the patterned surface are shown in FIG. 1B.

### Formation of Ordered Ring Arrays of Ag Nanostructures

After the formation of VE surface droplets on the patterned substrate, AgNO₃ precursor solution (sol.C) is allowed to pass through the microchamber at a flow rate of 1.5 mL/h as shown in FIG. 1B. The initial concentration of AgNO₃ precursor solution and the pH level of the reacting medium is adjusted for each case as listed in Table 1.

TABLE 1
Sets of operating conditions for the fabrication
of ordered ring arrays of AgNPs.

| | Ag | | | | | | | | |
|---|---|---|---|---|---|---|---|---|---|
| | nanostructure | S1 | S2 | S3 | S4 | S5 | S6 | S7 | S8 |
| Solution | pH | 10 | 10 | 10 | 10 | 10 | 10 | 9 | 11 |
| condition | AgNO₃ | 2 | 0.5 | 1 | 0.1 | 3 | 4 | 0.5 | 0.5 |
| | concen- | | | | | | | | |
| | tration (mM) | | | | | | | | |

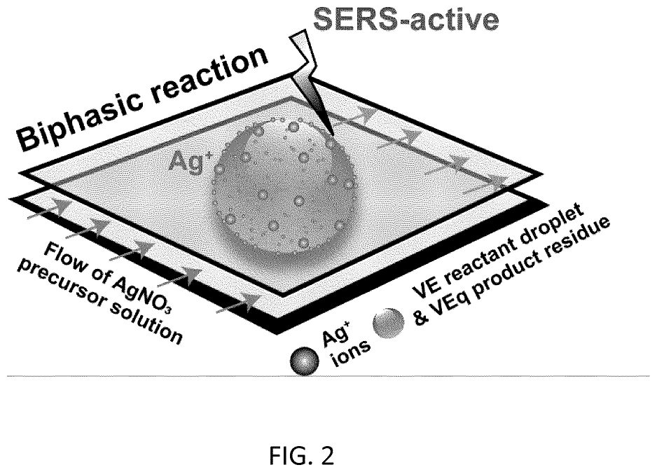

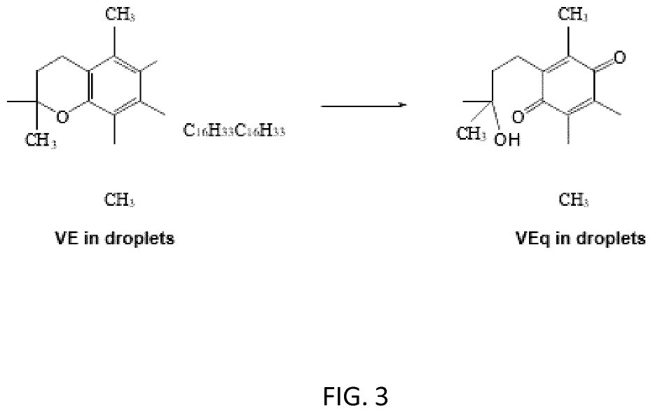

The Ag⁺ ions present in sol.C react with VE droplets at the interface to produce AgNPs and α-tocopherol quinone (VEq) (see FIG. 2), following the reaction mechanism presented in FIG. 3.³⁶ The reaction for the formation of AgNPs at the droplet interface is carried out in dark at ambient temperature. The reactive flow is left undisturbed for 7 h until the reaction is complete, and then the sol.C inside the microchamber is displaced using EtOH at a flow rate of 10 mL/h. During this last step, the reaction product (VEq) formed on the substrate is dissolved in EtOH and is carried away towards the outlet, leaving the Ag nanostructures formed on the substrate.

The biphasic reaction scheme at the interface of the VE droplets with the Ag⁺ ions in the alkaline medium to produce AgNPs is shown directly below:

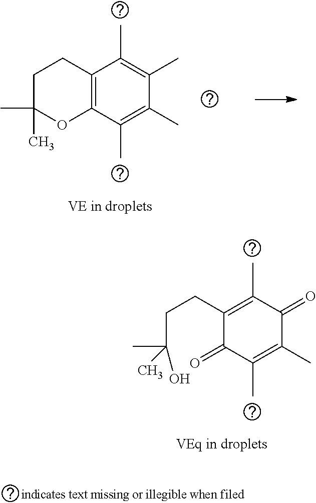

The molecular structures of model compounds related to environment and health care tested in these experiments are shown directly below, in which (A) R6G, (B) TC, (C) CP, and (D):

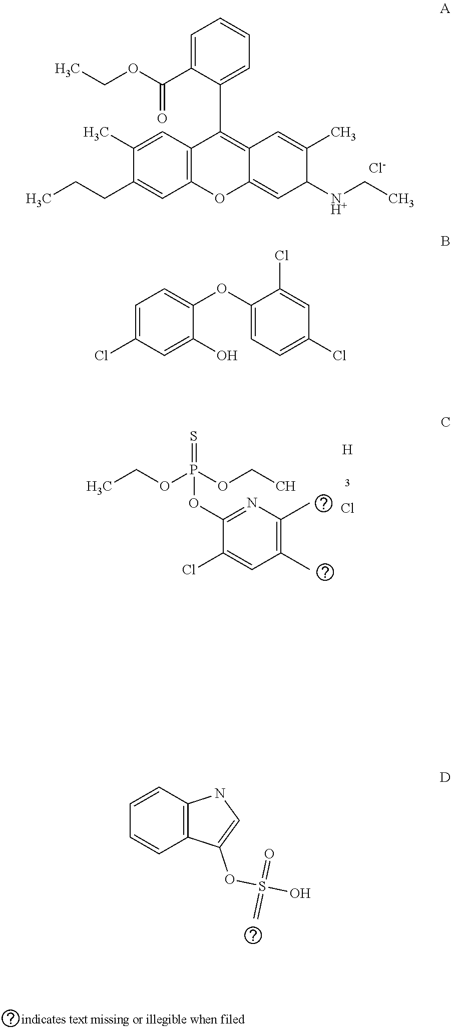

Finally, the substrate with ordered ring arrays of Ag nanostructures is ready for SERS detection, as shown in FIG. 1C. After the formation of AgNPs on the substrate, quantitative SERS detection is carried out with various environmental (R6G, CP, TC) and biological (indoxyl sulfate (IS)) related model compounds shown directly above.

### Characterization of Nanodroplets and Ag Nanostructures

The uniformity of VE droplets and the Ag nanostructures formed on the patterned substrate during the above processes are examined by using optical microscope (Nikon eclipse) equipped with 10× and 100× objectives (Olympus). Field emission scanning electron microscope (FESEM, Hitachi) is used to characterize the surface morphology and the size of Ag nanostructures. FESEM coupled with energy dispersive X-ray spectroscopy (EDX, Oxford) is used to confirm the elemental composition of the Ag nanostructures.

The quantitative detection of model compounds R6G, TC, CP, and IS are carried out using confocal Raman microscope (Renishaw in Via qontor confocal Raman microscope) coupled with 50× magnification lens and 0.5 W power, with lasers of 633, 785, 532, and 785 nm, respectively. Each Raman spectra is obtained with an acquisition time of 5 s and the accumulation was 5 times to reduce the noise.

### Results and Discussion

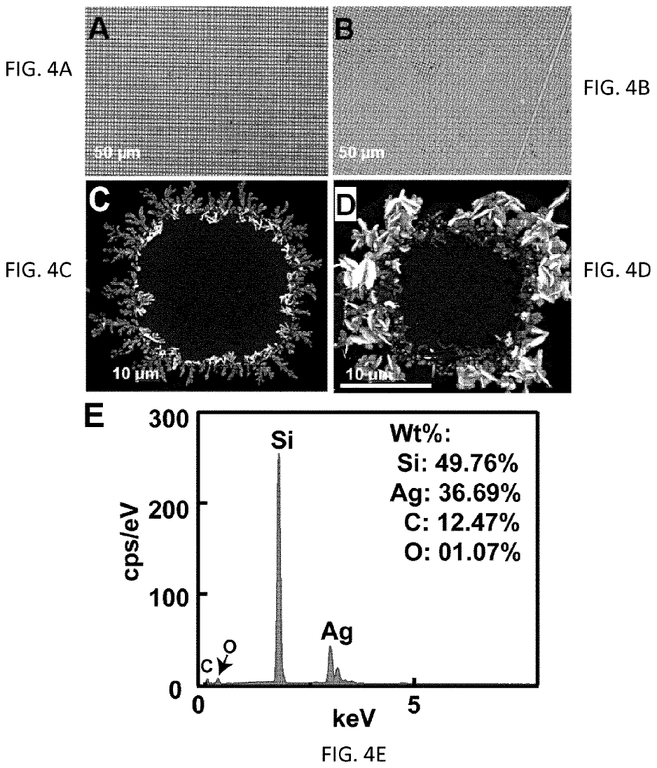

Structural and morphological features of the fabricated Ag nanostructures are determined using optical microscopy and FESEM. Optical images of structures S1 and S2 fabricated over a large area of 30 mm×10 mm are shown in FIGS. 4A and 4B, respectively. Structure Si suggests a dendritic structured morphology (FIG. 2C) and structure S2 suggests a sheet-like morphology (FIG. 4D). The average length of sheet and dendrite-like structures is about 1.4 μm. The elemental analysis of Ag nanostructures shown in FIG. 4E confirms the formation of silver, and the absence of oxygen peak suggests that the formed nanostructures are of silver instead of silver oxide.

This is attributed to the preferential growth and deposition of Ag nanostructures around the three phase contact line/droplet rim on the surface of the substrate is due to the biphasic reaction between VE droplet and precursor solution occurs at the interface of the droplet.³⁷ The surface nanodroplets generated by this solvent exchange approach are of highly uniform in size, immobile, and are stable with time even in the presence of continuous flow. This opens up the possibility of occurrence of reactions with high residence time and also provides the feasibility of refreshing the reactant at the droplet surface by continuous supply of the reactant into the reaction chamber. During the reaction process, the reactant VE is consumed leading to the increase in formation of VEq (reaction product) armored with Ag nanoparticles.

Even after the reaction is complete, the VEq droplets still remain on the surface of the substrate due to the insolubility of VEq in water saturated with octanol. The continuous flow of EtOH helps in displacing the soluble reaction product VEq from the hydrophobic microdomain towards the outlet of the microchamber. Due to larger dissolving flux at the edge of VE droplet, there exists an internal Marangoni flow due to spontaneous occurrence of interfacial gradients as a result of change in concentration within the droplets.³⁷

As the whole process is solution based, parameters such as flow rate, droplet volume, precursor concentration, and pH of the reaction medium are well controlled to maintain the uniformity of the structures throughout the substrate. The entire fabrication approach starting from generation of uniform sized VE droplets, followed by droplet reaction responsible for generation of uniform Ag nanostructures, and the final step of supplying analyte for SERS detection are well controlled.

### Stability of Synthesized Ag Nanostructures

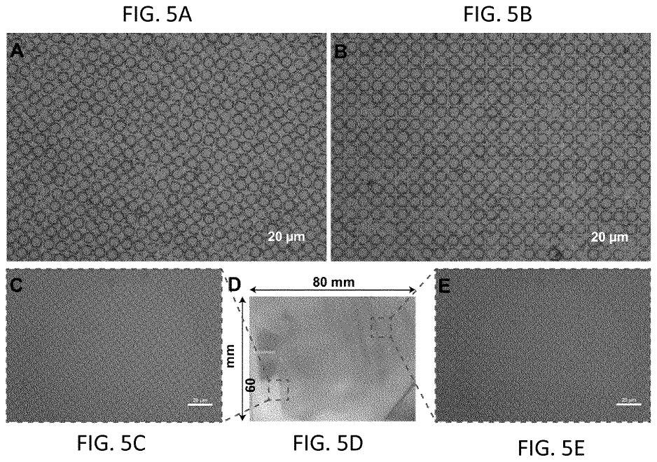

To determine how effectively the manufactured Ag nanostructures are adhered to the surface of the Si-wafer, the microchamber with Ag nanostructured substrate is flushed in both the directions inlet to outlet and vice versa using 40 mL of Milli-Q water (40×volume of microchamber). It is observed that there is no change in the surface coverage of Ag nanostructures even after flushing as shown in FIGS. 5A and 5B, indicating that the Ag nanostructures on the Si-wafer are stable to the flow.

### Large-Scale Synthesis of Ag Nanostructured SERS Substrates

The fabrication procedure is scaled up to produce more SERS active substrates in a single run of experiments. The dimensions of the microfluidic chamber are increased from (54.0 mm×11.0 mm×0.5 mm) to (81.5 mm×80.7 mm×0.5 mm), which allows for an increased number of SERS active substrates (each substrate (5 mm×5 mm)) from 4 to 100 in a single run. The system parameters are scaled up using MATLAB maintaining the same Peclet number as used in small microchamber. The flow rate of solution B during the droplet formation step is changed to 44 mL/h from 6 mL/h, maintaining the Pe equal to 89. The flow rate of the precursor solution during the droplet reaction step is changed to 11 mL/h from 1.5 mL/h, maintaining the Pe equal to 22. FIG. 5D shows the image of fabricated SERS substrate using larger chamber. Optical images of Ag nanostructured substrate over a large area fabricated using large chamber are shown in FIGS. 5C and 5E.

### SERS Detection of R6G Using Ring Arrays of Ag Nanostructures

Quantification is one of the most important parameters in chemical analysis to estimate the concentration of analyte molecules. The effect of morphological characteristics of Ag nanostructures on the quantification and sensitivity of SERS detection are demonstrated by using R6G as a model compound.

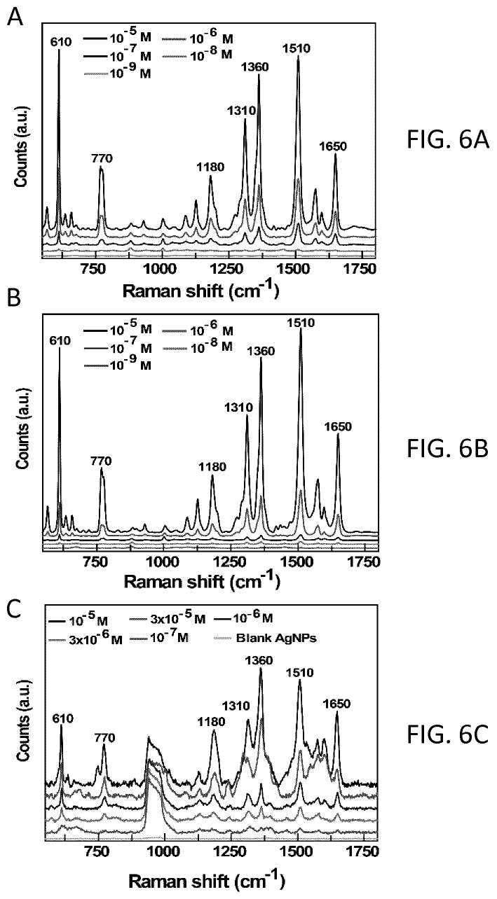

SERS analysis is performed on four different substrates of structure S1, and with each set of experiment five different spectra are collected from five different locations on the SERS substrate at a given concentration. The peak at 610 cm⁻¹ is chosen for the linear fitting to determine the quantitative relationship between SERS intensity and the concentration of R6G using the synthesized ring array of AgNPs substrates. One such plot of repeated SERS spectra is shown in FIG. 6A. The difference in slopes of any two linear plots is <0.1%, suggesting a very good repeatability of SERS measurements. Based on the above results, structures S1 (dendritic) and S2 (sheet-like) are selected for further analysis of SERS measurements using different model compounds. The characteristic vibrational modes in SERS spectra of R6G molecule are reported in Table S1.

High reproducibility of SERS signals with a minimum RSD of 4.3% and 3.2% are obtained using structure S1 and S2, respectively. This is due to the presence of highly ordered dendritic and sheet-like structures of AgNPs on the SERS substrate, suggesting a good reproducibility compared to the previous reports in literature (see Table 3). The LoD of R6G using structures S1 and S2 is 10⁻⁹ and 10⁻⁷ M, respectively.

The SERS spectra over the range of 10⁻⁵-10⁻⁹ M using structure S1 are presented in FIG. 6B. The SERS spectra over the range of 10⁻⁵-10⁻⁷ M using structure S2 are presented in FIG. 6C.

Greater LoD of 10⁻⁹ M, is achieved using structure S1 as a result of thicker ring arrays of AgNPs. Here, it is observed that the LoD of the ring of AgNPs increases with ring thickness, meaning as ring thickness increases, LoD also increases (Table S1).

TABLE S1
LoD as a function of ring thickness using R6G.

| Ag | | | | | | | | |
|---|---|---|---|---|---|---|---|---|
| structures | S1 | S2 | S3 | S4 | S5 | S6 | S7 | S8 |
| Ring thickness | 1.51 ± | 0.917 ± | 1.05 ± | 0.45 ± | 1.31 ± | 1.21 ± | Dispersed | Dispersed |
| (μm) | 0.2 | 0.015 | 0.3 | 0.02 | 0.2 | 0.2 | particles | particles |
| LoD (M) | 10₋₉ | 10₋₇ | 10₋₇ | 10₋₅ | 10₋₈ | 10₋₈ | 10₋₅ | 10₋₇ |

LoD of Ag structures S1 and S2 using various analytes tested in this study are reported in Table 2.

TABLE 2
LoD of R6G, TC, CP, and IS using Ag nanostructures S1 and S2

| | LoD | LoD | LoD | LoD |
|---|---|---|---|---|
| Ag | (M) | (M) | (M) | (M) |
| structure | R6G | TC | CP | IS |
| S1 | 10-9 | 10-5 | 10-7 | 10-5 |
| S2 | 10-7 | 5 × 10⁻⁵ | 10-6 | NA |

To date, some of the researchers have fabricated SERS substrates with an improved LoD of 10⁻¹¹ and 10⁻¹³ M using nano Au-films and Ag nanospheres, respectively.^{26,38} However, the main purpose of an highly-ordered SERS substrate is to improve the reproducibility of detection, and thus to determine the concentration of analyte molecules quantitatively. Table 3 summarizes the type of nanostructure, corresponding LoD, quantitative range, and relative standard deviation (RSD) of some the earlier works reported in literature.

TABLE 3
List of previously reported works on the fabrication of highly-ordered
structures for SERS analysis using R6G as a model analyte.

| | | | Quantitative | |
|---|---|---|---|---|
| | | LoD | range | RSD |
| Nanostructures | Synthesis method | (nM) | (M) | (%) |
| Ag nanodot¹⁷ | Laser deposition | 10-2 | NA | <5.00 |
| Au/Ag | NIL and Glow | 10-5 | 10-4-10-9 | 3.72 |
| nanoparticles¹⁸ | discharge | | | |
| Au/Ag nanorods¹⁹ | Nanofabrication | 10-3 | 10-5-10-11 | 6.50 |
| Ag nanoparticles²⁷ | Nanofabrication | 10-2 | 10-8-10-11 | 3.40 |
| Ag 3D micro-lens | Nanofabrication | 10-1 | 10-5-10-10 | 6.12 |
| array nanostructure²⁸ | | | | |
| Ag-graphene | Surface plasmon | 10-6 | 10-10-10-15 | 12.00 |
| nanohole³⁹ | lithography | | | |
| Ag nanosheets⁴⁰ | Wet chemical | 10-3 | NA | <5.00% |

### SERS Detection of Triclosan (TC)

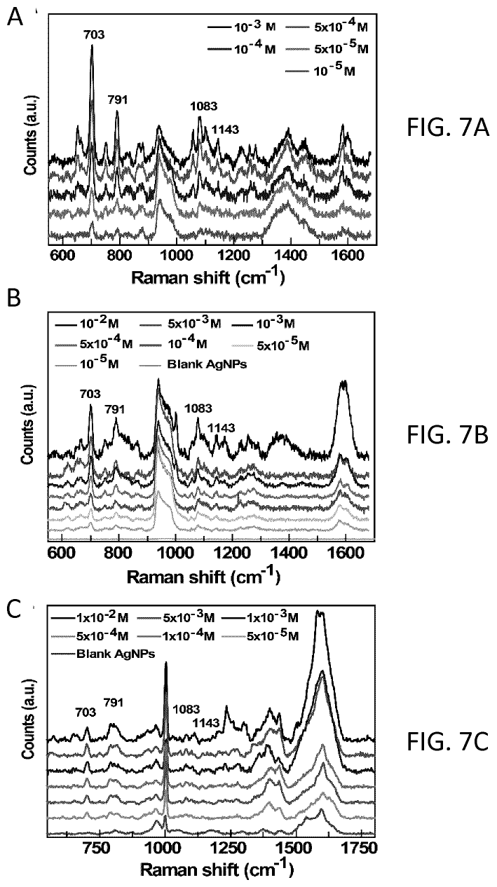

TC is a synthetic antimicrobial responsible for critical side effects to human health including severe allergies, hormonal diseases, and cancers etc.⁴¹⁻⁴⁴ Despite its hazardous effects, it is still used in the production of antibacterial soaps, toothpastes, cosmetics, fabrics, and detergents. Hence, there is a need for quantitative detection of this molecule. To verify the repeatability of SERS detection, SERS analysis is performed on four different substrates with structure S1. In each set of experiments, five different spectra are collected from five different locations on the SERS substrate at a given concentration. One such plot of repeated SERS spectra is shown in FIG. 7A The difference in slopes of any two linear plots is <0.1%, suggesting a very good repeatability of SERS measurements using TC in aqueous solutions.

The SERS spectra over the range of 10⁻²-10⁻⁵ M using structures S1 and S2 are presented in FIGS. 7B and 7C, respectively. A high reproducibility of SERS signals with a minimum RSD of 4.5% and 3.2% are obtained using structures S1 and S2, respectively. The LoD of TC using structures S1 and S2 are 10⁻⁵ M and 5×10⁻⁵ M, respectively. The characteristic vibrational modes in SERS spectra of TC molecule are reported in Table 4.

TABLE 4
Vibrational modes in SERS spectra of TC molecule.

| Wave number | |
|---|---|
| (cm⁻¹) | Vibration mode |
| 703 | C—Cl stretching² |
| 791, 1083 | Aromatic C—Cl stretching³ |
| 1143 | C—O—C (asymmetric stretching)² |
| 1611 | C═C (stretching)² |

### SERS Detection of Chlorpyrifos (CP)

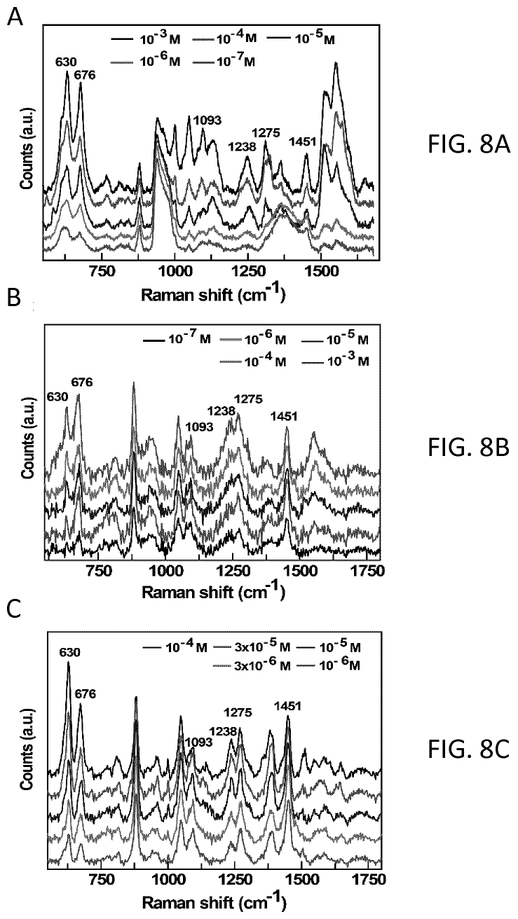

CP is one of the most used organophosphorus pesticide in agriculture.^{45,46} CP present on the surface of the crops and fruits is found to have toxic effects to human health.^{47,48} Until now, several groups have reported nanomolar limit of detection using SERS,⁴⁹⁻⁵⁰ but the quantitative detection of CP is still challenging. To verify the repeatability of SERS detection, SERS analysis is performed on four different substrates of structure S1. In each set of experiments, five different spectra are collected from five different locations on the SERS substrate at a given concentration. One such plot of repeated SERS spectra is shown in FIG. 8A. The difference in slopes of any two linear plots is <0.05%, suggesting a very good repeatability of SERS measurements using CP in aqueous solutions.

The SERS spectra over the range of 10⁻⁴-10⁻⁷ M using structures S1 and S2 are presented in FIGS. 8B and 8C, respectively. A high reproducibility of SERS signals with a minimum RSD of 4.2% and 3.3% are obtained using structures S1 and S2, respectively. The LoD of CP using structures S1 and S2 are 10⁻⁷ and 10⁻⁶ M, respectively. The characteristic vibrational modes in SERS spectra of CP molecule are reported in Table 5.

TABLE 5
Vibrational modes in SERS spectra of CP molecule.

| Wave number | |
|---|---|
| (cm⁻¹) | Vibration mode |
| 630, 676 | P═S stretching⁴ |
| 970 | Cl—ring wagging⁴ |
| 1238, 1275 | Cl—ring vibration⁴ |
| 1569 | C═C stretching⁴ |

### SERS Detection of in Oxy Sulfate (IS)

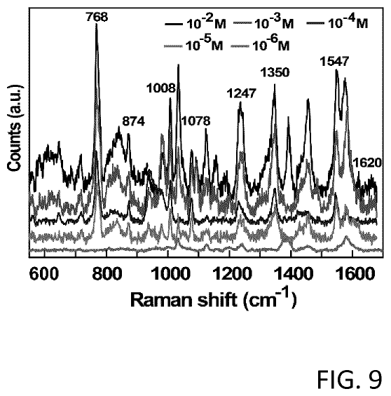

Chronic kidney disease (CKD) is now widely recognized as a global public health issue.⁵¹⁻⁵³ IS raises oxidative stress and lowers antioxidant capability, all of which are linked to tubulointerstitial damage. SERS measurements of biological toxin (IS) are performed in PBS buffer solution. At first, the Raman spectra of IS in PBS buffer is examined and the spectrum is compared to that of only PBS buffer solution a correlation between intensity and concentration at a peak intensity of 610 cm⁻¹ with an R² value of 0.986 and RSD value of 7.6% is noted for structure S5. The SERS spectra of structure S6, has a correlation between intensity and concentration with an R² value of 0.998 and RSD value of 5.1%. Peaks at 1078 and 1122 cm⁻¹ are attributed to the vibration of IS.⁵⁴ The SERS spectra over the range of 10⁻²-10⁻⁵ M using structure S1 are presented in FIG. 9A. The LoD of IS using structure S1 is reported as 10⁻⁵ M. This initial study of IS opens up the possibility of toxin detection using the SERS active AgNPs ring structures.

### Growth Study of Ag Nanostructures on the Patterned Si-Substrate

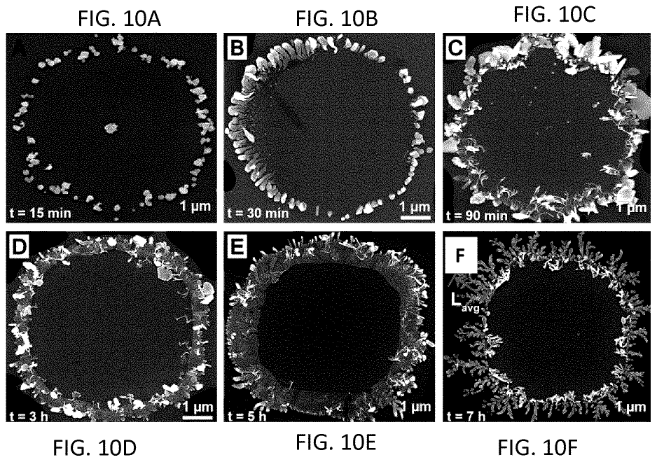

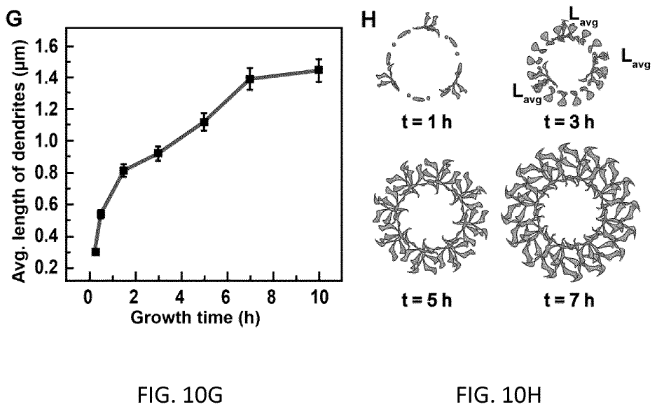

To understand the sequential growth process of Ag nanostructure S1, beginning from the formation of AgNPs to formation of final dendritic structures, series of reactions are performed as a function of time with an initial AgNO₃ concentration of 2 mM at a flow rate of 1.5 mL/h. FESEM images shown in FIGS. 10A-10F suggest that the formation of Ag dendritic structures occurs in two different phases of AgNPs nucleation and diffusive growth. When the AgNO₃ solution comes into contact with the VE droplet at the interface, the silver ions are reduced and subsequently nucleated into silver metal nanoparticles along the interface. Initially, during the first 15 min (t<15 min), the AgNO₃ precursor solution reacts with the VE droplets (reducing agent) leading to the nucleation of Ag metal nanoparticles.

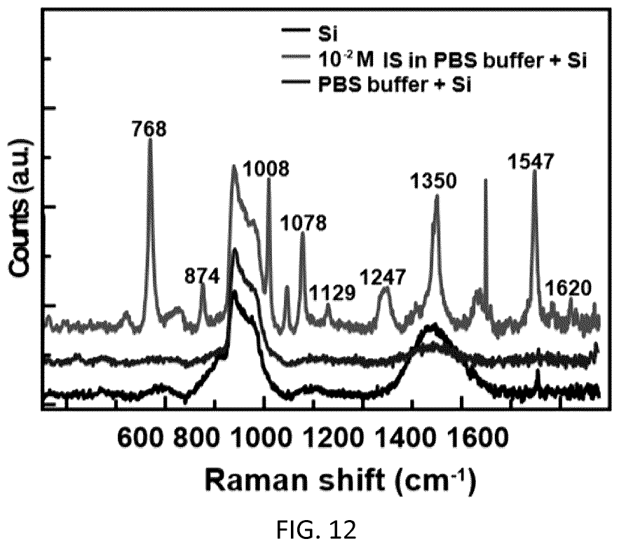

The supply of AgNO₃ precursor solution is continuous, and as time proceeds the metal nanoparticles gradually grow towards AgNSs and AgNDs. This study suggests that the AgNPs nucleated to form metal silver nanoparticles, followed by sheet-like, and dendrite-like structures suggesting diffusive growth, with increase in AgNO₃ concentration. The average length of the dendrite and the number of dendritic nanostructures increased with time resulting in the formation of dense silver nanostructures (FIG. 10G). This observation concludes that the initial production of smaller AgNPs is followed by the ring assembly of dendritic nanostructures which is shown schematically in FIG. 10H. To confirm the reproducibility of structure S1, another set of growth process is shown in FIG. 12.

### Effect of Initial Precursor Concentration and pH on the Formation of Ordered Ring Arrays of Ag Nanostructures

To study the effect of initial concentration of AgNO₃, various concentrations of precursor salt solution at pH 10 are chosen as reported in Table 1. Optical microscopic images of ring array of Ag nanostructures produced with initial concentrations of 2.0, 0.5, 1.0, 0.1, 3.0, and 4.0 mM are collected for structures S1, S2, S3, S4, S5, and S6, respectively.

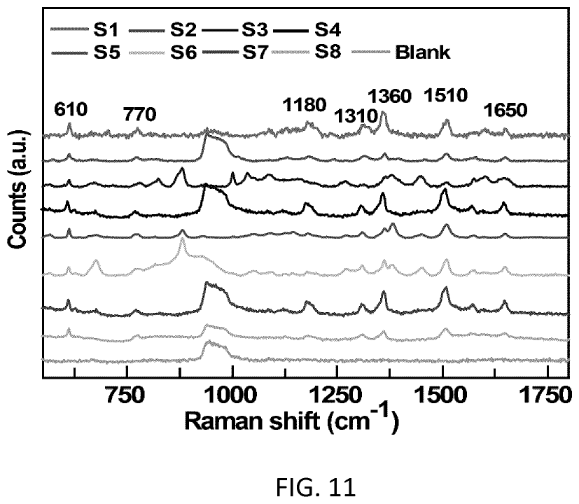

FIG. 11 shows the Raman spectra of R6G obtained for all the eight Ag nanostructures (S1-S8) reported in Table 1, at their LoD concentrations. Due to poor surface coverage of AgNPs, structures S4 and S7 reported an LoD of 10⁻⁵ M, similar to no SERS activity. Structures S3 and S8 reported an R² value of 0.994 and 0.976, with a minimum RSD of 4.8% and 8.2%, respectively. From this observation, it is clear that despite of same LoD (10⁻⁷ M) for structures S2, S3, and S8, better accuracy (R²=0.998) and reproducibility (RSD=3.2%) is exhibited for structure S2 due to the presence of highly ordered uniform structures of AgNPs on the SERS substrate. Similarly, structures S5 and S6 with an LoD of 10⁻⁸ M, reported an R² value of 0.986 and 0.998, with a minimum RSD of 7.6% and 5.1%, respectively. The poor reproducibility of these structures (S5 and S6) is due to uneven distribution of structures of AgNPs on the SERS substrate. Hence, structure S1 is chosen to check the repeatability of the SERS data using R6G.

Ordered ring arrays of small Ag nanoparticles with an average thickness of 450±20 nm are obtained using 0.1 mM AgNO₃ at pH 10. When the concentration of AgNO₃ is increased to 0.5 mM, sheet-like Ag nanostructures are observed along with some AgNPs with an average ring thickness increased to 917±15 nm. For a concentration of 1 mM AgNO₃, nanosheet structures are observed along with some dendritic structures with an average ring thickness of 1.05±0.31 μm. The number of dendritic structures increases with increase in the concentration of AgNO₃ solution to 2 and 3 mM, and the average ring thickness increased to 1.51±0.27 μm and 1.31±0.27 μm, respectively. Finally, with an increase in the initial concentration of the precursor solution from 0.1 to 3 mM, the ring thickness of ordered Ag nanostructures is increased from 450±20 nm to 1.31±0.27 μm. At 4 mM concentration of AgNO₃, a new small ring is formed in between the void space of four adjacent rings which lowers the average ring thickness to 1.21±0.24 μm. FESEM images were collected for the ring thickness of the above synthesized structures (S1-S6).

To study the effect of pH, precursor salt solution with three different pH values 9, 10, and 11 at an initial concentration of 0.5 mM are studied. Optical microscopic images of Ag nanostructures were produced with pH values of 9, 10, and 11 (structure S2, S7, and S8, respectively).

Decrease in pH value (pH=9) of the reacting medium results in the formation of a cluster of silver nanoparticles deposited at the center of the microdomain and a relatively less number of silver nanoparticles are formed at the outer rim (structure S2 and S7)). At low pH values of the reaction medium, the reaction rate in producing Ag nanostructures is limited due to decrease in the availability of OH— ions. As a result, Ag nanostructures that are formed initially act as a catalyst for additional growth leading to the formation of a cluster. After the formation of a denser cluster, it is submerged into the droplet and is settled down on to the Si substrate as shown in (structure S7). At a pH value of 11, the AgNO₃ precursor solution reacted with OH-ions to form Ag₂O. A large amount of Ag₂O is suspended in bulk and then precipitated on to the substrate during the reaction process, leading to the formation of dispersed particles with disorderliness on to the substrate, as shown in (structure S8).

Optimization of the above operating conditions show that highly uniform and thick ring array of Ag nanostructures are obtained for structures S1 (2 mM AgNO₃, pH 10) and S2 (0.5 mM AgNO₃, pH 10). From the above results, it's clear that the morphology of Ag nanostructures depends upon the initial concentration of the precursor solution, volume of the VE droplet, and pH of the reaction medium.

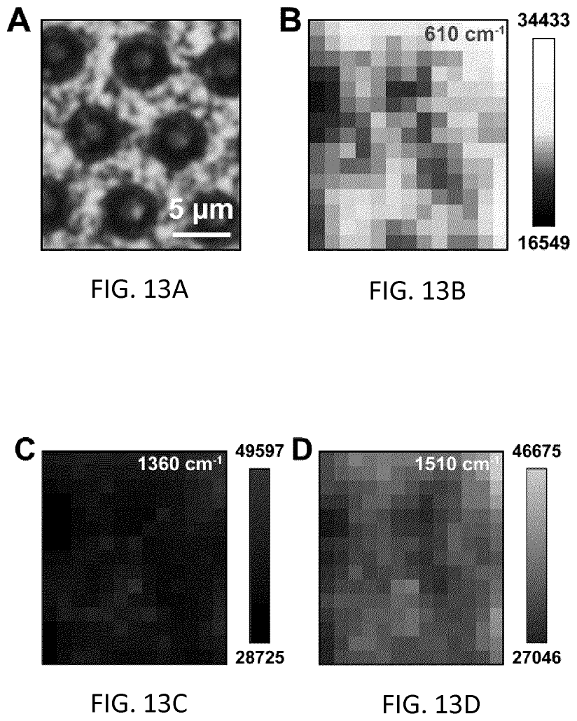

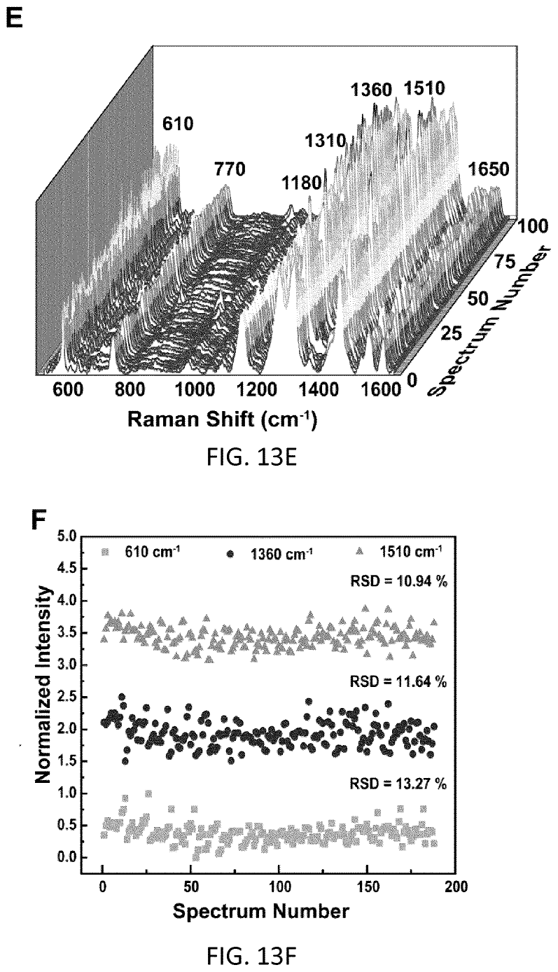

According to embodiments, oft and flexible polymer substrates are used to produced Ag nanoparticles by following the above described droplet reaction process. FIGS. 13A-13F show the images of the Ag nanoparticles on PDMS with microwell structures shown in FIGS. 13A-13D and the mapping of Raman spectra of R6G on the substrate shown in FIG. 13E-13F. FIG. 13A is the optical image taken from Confocal Raman while mapping, it's the actual region used for mapping. FIGS. 13B-13D are 2D live mapping images at different peaks of the same optical region mentioned in FIG. 13A. The analyte used is Rhodamine 6G (10\hat{ }-5 M) for mapping. FIG. 13E is a combination of R6G spectra from 100 different locations on the microwell substrate. FIG. 13F shows peaks 610, 1360, and 1510 and the relative standard derivation (RSD) of approximately 200 spectra obtained from mapping of R6G. Mainly to show the mapping region and corresponding optical image while scanning and show the RSD of peaks.

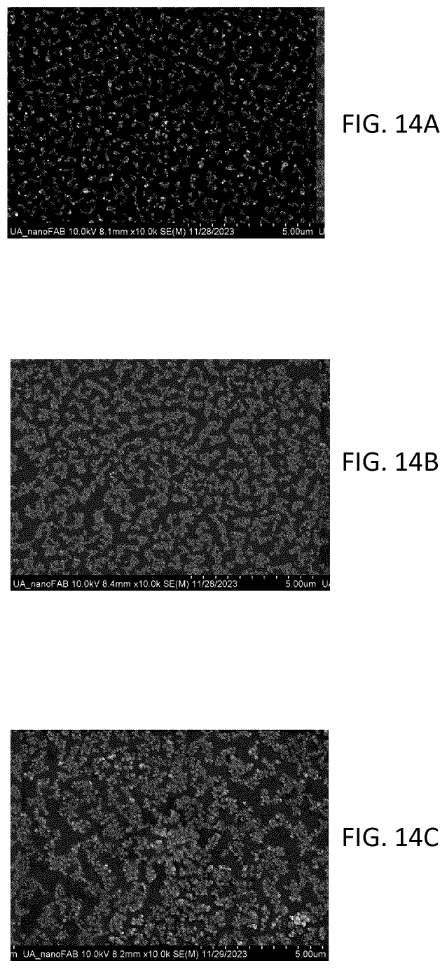

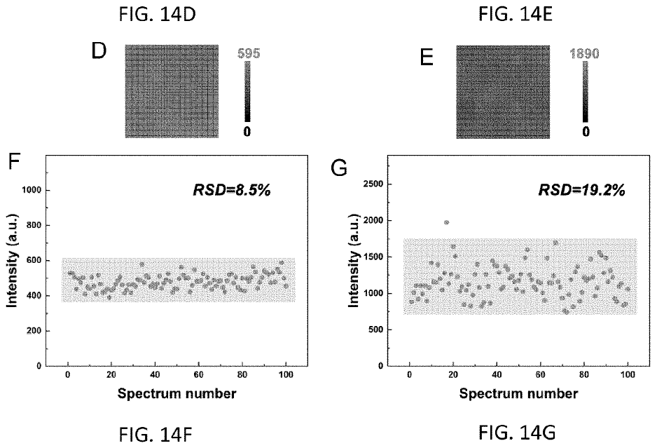

FIGS. 14A-14C show the images of the Ag nanoparticles on plain PDMS, while FIGS. 14D-14G show Raman mapping of R6G at the concentration of 108 M, and the relative standard derivation of the signal intensity.

According to embodiments, the PDMS substrates are transparent and deformable, and can be placed on sample surfaces for in-situ detection. According to embodiments, the PDMS substrate is provided as a film or is molded in any desired shape. According to embodiments, the PDMS has a thickness of 2 micrometers to 700 micrometers.

### CONCLUSIONS

In summary, embodiments of the present invention provide a flow controlled, solution-based approach to synthesize highly ordered and stable ring arrays of Ag nanostructures with sheet-like and dendritic structured morphology. This droplet-based biphasic reaction approach is used to create eight different types of Ag nanostructures under various operating conditions. These nanostructures demonstrate good reproducibility of SERS measurements with a minimum relative standard deviation of ~3.2%. The whole process involving generation of uniform sized VE droplets, followed by droplet reaction responsible for generation of uniform Ag nanostructures, and the final step of supplying analyte for SERS detection are well controlled. The process parameters such as flow rate, droplet volume, precursor concentration, pH of the reaction medium, and reaction time are tuned to maintain the uniformity of the structures throughout the substrate. It has been found that the distribution of Ag nanostructures is strongly dependent on the precursor AgNO₃ concentration, pH of the reaction medium, and reaction time. The approach is scalable, and able to increase the number of SERS substrates from 4 to 100 in a single run. It demonstrates the quantitative detection and repeatability of SERS measurements using Ag nanostructures by analyzing three environmental (R6G, CP, TC) and a biological model compound (IS). These nanostructures exhibit strong quantitative detection down to 10⁻⁷-10⁻⁹M. Moreover, the fabricated substrate is of one-use and does not show any memory effect of the previous sample solutions, which is also responsible for good reproducibility. This novel cost-effective approach for the fabrication of highly ordered Ag nanostructures with good reproducibility and quantification range is useful for a wide range of applications in analytical techniques related to environmental pollutants, cytotoxicity of biological components, consumables, and advanced materials.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

### REFERENCES

(1) Reiner, E. J.; Clement, R. E.; Okey, A. B.; Marvin, C. H. Advances in analytical techniques for polychlorinated dibenzo-p-dioxins, polychlorinated dibenzofurans and dioxin-like PCBs. Analytical and bioanalytical chemistry 2006, 386, 791-806.
(2) Pushkarsky, M. B.; Dunayevskiy, I. G.; Prasanna, M.; Tsekoun, A. G.; Go, R.; Patel, C. K. N. Highsensitivity detection of TNT. Proceedings of the National Academy of Sciences 2006, 103, 19630-19634.
(3) Homola, J. Surface plasmon resonance sensors for detection of chemical and biological species. Chemical reviews 2008, 108, 462-493.
(4) Baker, B. R.; Lai, R. Y.; Wood, M. S.; Doctor, E. H.; Heeger, A. J.; Plaxco, K. W. An electronic, aptamer-based small-molecule sensor for the rapid, label-free detection of cocaine in adulterated samples and biological fluids. Journal of the American Chemical Society 2006, 128, 3138-3139.
(5) Langer, J.; Jimenez de Aberasturi, D.; Aizpurua, J.; Alvarez-Puebla, R. A.; Auguie, B.; Baumberg, J. J.; Bazan, G. C.; Bell, S. E.; Boisen, A.; Brolo, A. G., et al. Present and future of surface-enhanced Raman scattering. ACS nano 2019, 14, 28-117.
(6) Pilot, R.; Signorini, R.; Durante, C.; Orian, L.; Bhamidipati, M.; Fabris, L. A review on surface enhanced Raman scattering. Biosensors 2019, 9, 57.
(7) Li, D.; Yao, D.; Li, C.; Luo, Y.; Liang, A.; Wen, G.; Jiang, Z. Nanosol SERS quantitative analytical method: A review. TrAC Trends in Analytical Chemistry 2020, 127, 115885.
(8) Fateixa, S.; Nogueira, H. I.; Trindade, T. Hybrid nanostructures for SERS: materials development and chemical detection. Physical Chemistry Chemical Physics 2015, 17, 21046-21071.
(9) Li, M.; Dyett, B.; Yu, H.; Bansal, V.; Zhang, X. Functional femtoliter droplets for ultrafast nanoextraction and supersensitive online microanalysis. Small 2019, 15, 1804683.
(10) Yang, S.; Dai, X.; Stogin, B. B.; Wong, T.-S. Ultrasensitive surface-enhanced Raman scattering detection in common fluids. Proceedings of the National Academy of Sciences 2016, 113, 268-273.
(11) Rodriguez-Lorenzo, L.; Alvarez-Puebla, R. A.; Pastoriza-Santos, I.; Mazzucco, S.; Stephan, O.; Kociak, M.; Liz-Marzán, L. M.; Garcia de Abajo, F. J. Zeptomol detection through controlled ultrasensitive surface-enhanced Raman scattering. Journal of the American Chemical Society 2009, 131, 4616-4618.
(12) Mosier-Boss, P. A. Review of SERS substrates for chemical sensing. Nanomaterials 2017, 7, 142.
(13) Oh, Y.-J.; Kang, M.; Park, M.; Jeong, K.-H. Engineering hot spots on plasmonic nanopillar arrays for SERS: A review. BioChip Journal 2016, 10, 297-309.
(14) Cheng, C.; Yan, B.; Wong, S. M.; Li, X.; Zhou, W.; Yu, T.; Shen, Z.; Yu, H.; Fan, H. J. Fabrication and SERS performance of silver-nanoparticle-decorated Si/ZnO nanotrees in ordered arrays. ACS applied materials & interfaces 2010, 2, 1824-1828.
(15) Liu, D.; Wang, Q.; Hu, J. Fabrication and characterization of highly ordered Au nanocone array patterned glass with enhanced SERS and hydrophobicity. Applied Surface Science 2015, 356, 364-369.
(16) Chu, J.; Zhao, Y.; Li, S.-H.; Li, W.-W.; Chen, X.-Y.; Huang, Y.-X.; Chen, Y.-P.; Qu, W.-G.; Yu, H.-Q.; Xu, A.-W., et al. A highly-ordered and uniform sunflower-like dendritic silver nanocomplex array as reproducible SERS substrate. Rsc Advances 2015, 5, 3860-3867.
(17) Xu, S.; Jiang, S.; Hu, G.; Wei, J.; Wang, L.; Zhang, J.; Li, Q. Highly ordered graphene-isolated silver nanodot arrays as SERS substrate for detection of urinary nucleosides. Laser Physics 2015, 25, 115601.
(18) Cai, J.; Liu, R.; Jia, S.; Feng, Z.; Lin, L.; Zheng, Z.; Wu, S.; Wang, Z. SERS hotspots distribution of the highly ordered noble metal arrays on flexible substrates. Optical Materials 2021, 122, 111779.
(19) Chen, B.; Meng, G.; Huang, Q.; Huang, Z.; Xu, Q.; Zhu, C.; Qian, Y.; Ding, Y. Green synthesis of large-scale highly ordered core@shell nanoporous Au@Ag nanorod arrays as sensitive and reproducible 3D SERS substrates. ACS applied materials & interfaces 2014, 6, 15667-15675.
(20) Lu, Y.-C.; Chiang, W.-H.; Liu, C.-Y.; Chu, J. P.; Ho, H.-C.; Hsueh, C.-H. Wafer-scale SERS metallic nanotube arrays with highly ordered periodicity. Sensors and Actuators B: Chemical 2021, 329, 129132.
(21) Cecchini, M. P.; Turek, V. A.; Paget, J.; Kornyshev, A. A.; Edel, J. B. Self-assembled nanoparticle arrays for multiphase trace analyte detection. Nature materials 2013, 12, 165-171.
(22) Henzie, J.; Grunwald, M.; Widmer-Cooper, A.; Geissler, P. L.; Yang, P. Self-assembly of uniform polyhedral silver nanocrystals into densest packings and exotic superlattices. Nature materials 2012, 11, 131-137.
(23) Huang, Z.; Meng, G.; Huang, Q.; Yang, Y.; Zhu, C.; Tang, C. Improved SERS performance from Au nanopillar arrays by abridging the pillar tip spacing by Ag sputtering. Advanced Materials 2010, 22, 4136-4139.
(24) Kang, H.; Heo, C.-J.; Jeon, H. C.; Lee, S. Y.; Yang, S.-M. Durable plasmonic cap arrays on flexible substrate with real-time optical tunability for high-fidelity SERS devices. ACS applied materials & interfaces 2013, 5, 4569-4574.
(25) Hatab, N. A.; Hsueh, C.-H.; Gaddis, A. L.; Retterer, S. T.; Li, J.-H.; Eres, G.; Zhang, Z.; Gu, B. Freestanding optical gold bowtie nanoantenna with variable gap size for enhanced Raman spectroscopy. Nano letters 2010, 10, 4952-4955.
(26) Wang, J.; Qiu, C.; Mu, X.; Pang, H.; Chen, X.; Liu, D. Ultrasensitive SERS detection of rhodamine 6G and p-nitrophenol based on electrochemically roughened nano-Au film. Talanta 2020, 210, 120631.
(27) Xu, D.; Teng, F.; Wang, Z.; Lu, N. Droplet-confined electroless deposition of silver nanoparticles on ordered superhydrophobic structures for high uniform SERS measurements. ACS Applied Materials & Interfaces 2017, 9, 21548-21553.
(28) Zhang, C.; Chen, S.; Wang, J.; Shi, Z.; Du, L. Reproducible Flexible SERS Substrates Inspired by Bionic Micro-Nano Hierarchical Structures of Rose Petals. Advanced Materials Interfaces 2022, 9, 2102468.
(29) Lohse, D.; Zhang, X., et al. Surface nanobubbles and nanodroplets. Reviews of modern physics 2015, 87, 981.
(30) Li, Z.; Kiyama, A.; Zeng, H.; Lohse, D.; Zhang, X. Speeding up biphasic reactions with surface nanodroplets. Lab on a Chip 2020, 20, 2965-2974.
(31) Bao, L.; Rezk, A. R.; Yeo, L. Y.; Zhang, X. Highly ordered arrays of femtoliter surface droplets. small 2015, 11, 4850-4855.
(32) Wei, Z.; Dabodiya, T. S.; Chen, J.; Lu, Q.; Qian, J.; Meng, J.; Zeng, H.; Qian, H.; Zhang, X. In-situ fabrication of metal oxide nanocaps based on biphasic reactions with surface nanodroplets. Journal of colloid and interface science 2022, 608, 2235-2245.
(33) Zhang, X.; Ren, J.; Yang, H.; He, Y.; Tan, J.; Qiao, G. G. From transient nanodroplets to permanent nanolenses. Soft Matter 2012, 8, 4314-4317.
(34) Lu, Q.; Xu, Q.; Meng, J.; How, Z. T.; Chelme-Ayala, P.; Wang, X.; Gamal El-Din, M.; Zhang, X. Surface microlenses for much more efficient photodegradation in water treatment. ACS ES&T Water 2022, 2, 644-657.
(35) Zhang, X.; Lu, Z.; Tan, H.; Bao, L.; He, Y.; Sun, C.; Lohse, D. Formation of surface nanodroplets under controlled flow conditions. Proceedings of the National Academy of Sciences 2015, 112, 9253-9257.
(36) Zhang, L.; Shen, Y.; Xie, A.; Li, S.; Jin, B.; Zhang, Q. One-step synthesis of monodisperse silver nanoparticles beneath vitamin E Langmuir monolayers. The Journal of Physical Chemistry B 2006, 110, 6615-6620.
(37) Deegan, R. D.; Bakajin, O.; Dupont, T. F.; Huber, G.; Nagel, S. R.; Witten, T. A. Capillary flow as the cause of ring stains from dried liquid drops. Nature 1997, 389, 827-829.
(38) Kumar, E. A.; Barveen, N. R.; Wang, T.-J.; Kokulnathan, T.; Chang, Y.-H. Development of SERS platform based on ZnO multipods decorated with Ag nanospheres for detection of 4-nitrophenol and rhodamine 6G in real samples. Microchemical Journal 2021, 170, 106660.
(39) Jie, Z.; Zenghe, Y.; Tiancheng, G.; Yunfei, L.; Dapeng, W.; Yong, Z. Graphene/Ag nanoholes composites for quantitative surface-enhanced Raman scattering. Optics Express 2018, 26, 22432-22439.
(40) He, L.; Huang, J.; Xu, T.; Chen, L.; Zhang, K.; Han, S.; He, Y.; Lee, S. T. Silver nanosheet-coated inverse opal film as a highly active and uniform SERS substrate. Journal of Materials Chemistry 2012, 22, 1370-1374.
(41) Cherednichenko, G.; Zhang, R.; Bannister, R. A.; Timofeyev, V.; Li, N.; Fritsch, E. B.; Feng, W.; Barrientos, G. C.; Schebb, N. H.; Hammock, B. D., et al. Triclosan impairs excitation-contraction coupling and Ca2+ dynamics in striated muscle. Proceedings of the National Academy of Sciences 2012, 109, 14158-14163.
(42) Allmyr, M.; Adolfsson-Erici, M.; McLachlan, M. S.; Sandborgh-Englund, G. Triclosan in plasma and milk from Swedish nursing mothers and their exposure via personal care products. Science of the Total Environment 2006, 372, 87-93.
(43) Bertelsen, R. J.; Longnecker, M. P.; Lovik, M.; Calafat, A. M.; Carlsen, K.-H.; London, S. J.; Lodrup Carlsen, K. Triclosan exposure and allergic sensitization in Norwegian children. Allergy 2013, 68, 84-91.
(44) Yueh, M.-F.; Taniguchi, K.; Chen, S.; Evans, R. M.; Hammock, B. D.; Karin, M.; Tukey, R. H. The commonly used antimicrobial additive triclosan is a liver tumor promoter. Proceedings of the National Academy of Sciences 2014, 111, 17200-17205.
(45) Wang, K.; Sun, D.-W.; Pu, H.; Wei, Q. Two-dimensional Au@Ag nanodot array for sensing dual fungicides in fruit juices with surface-enhanced Raman spectroscopy technique. Food chemistry 2020, 310, 125923.
(46) Uddin, R.; Iqbal, S.; Khan, M. F.; Parveen, Z.; Ahmed, M.; Abbas, M. Determination of pesticide residues in rice grain by solvent extraction, column cleanup, and gas chromatography-electron capture detection. Bulletin of environmental contamination and toxicology 2011, 86, 83-89.
(47) Fu, Y.; Liu, F.; Zhao, C.; Zhao, Y.; Liu, Y.; Zhu, G. Distribution of chlorpyrifos in rice paddy environment and its potential dietary risk. Journal of Environmental Sciences 2015, 35, 101-107.
(48) Adgate, J. L.; Barr, D. B.; Clayton, C. A.; Eberly, L. E.; Freeman, N.; Lioy, P. J.; Needham, L. L.; Pellizzari, E. D.; Quackenboss, J. J.; Roy, A., et al. Measurement of children's exposure to pesticides: analysis of urinary metabolite levels in a probability-based sample. Environmental health perspectives 2001, 109, 583-590.
(49) Liu, Y.; Zhang, Y.; Wang, H.; He, B. Quantitative detection of pesticides based on SERS and gold colloid. International Conference on Computer and Computing Technologies in Agriculture. 2015; pp 587-596.
(50) MB, B.; Manippady, S. R.; Saxena, M.; John, N. S.; Balakrishna, R. G.; Samal, A. K. Gold Nanorods as an efficient substrate for the detection and degradation of pesticides. Langmuir 2020, 36, 7332-7344.
(51) Leong, S. C.; Sirich, T. L. Indoxyl sulfate—review of toxicity and therapeutic strategies. Toxins 2016, 8, 358.
(52) Brydges, C. R.; Fiehn, O.; Mayberg, H. S.; Schreiber, H.; Dehkordi, S. M.; Bhattacharyya, S.; Cha, J.; Choi, K. S.; Craighead, W. E.; Krishnan, R. R., et al. Indoxyl sulfate, a gut microbiome-derived uremic toxin, is associated with psychic anxiety and its functional magnetic resonance imaging-based neurologic signature. Scientific reports 2021, 11, 1-14.
(53) Hung, S.-C.; Kuo, K.-L.; Wu, C.-C.; Tarng, D.-C. Indoxyl sulfate: a novel cardiovascular risk factor in chronic kidney disease. Journal of the American Heart Association 2017, 6, e005022.
(54) Elumalai, B.; Prakasarao, A.; Ganesan, B.; Dornadula, K.; Ganesan, S. Raman spectroscopic characterization of urine of normal and oral cancer subjects. Journal of Raman Spectroscopy 2015, 46, 84-93.

1. A process of fabricating silver nanoparticles from surface nanodroplet reaction comprising:
placing a chemically micro-patterned substrate inside a narrow fluid chamber;
filling the chamber with a ternary mixture (sol.A);
replacing the ternary mixture by water saturated with Vitamin E (sol.B) to form droplets of Vitamin E (VE) on the substrate with hydrophobic micro-patterns;
providing a precursor solution (sol.C) to the substrate by passing the precursor solution through the microchamber;
providing Vitamin E (VE) droplet liquid on the micro-patterned substrate; and
reacting the precursor solution with the VE droplet liquid at a biphasic interface of the droplets on the substrate leading to the nucleation of AgNPs and subsequent growth towards nanostructures.

2. The process of claim 1 further comprising first creating the substrate with hydrophobic micropatterns using an OTS-coated Si or glass wafer using a photo-lithography method, or creating the substrates of plain polydimethylsiloxane (PDMS) or PDMS with microwells.

3. The process of claim 1 wherein the ternary mixture comprises water, ethanol (or methanol, propanol, butanol, acetone, or other organic solvents that are miscible with both water and VE), and VE with a volume ratio of 10:90:2.2.

4. The process of claim 1 wherein the water saturated with octanol replaces the ternary mixture at a constant flow rate of 5 mL/h.

5. The process of claim 1 wherein the precursor solution is AgNO₃.

6. The process of claim 1 wherein the precursor solution is provided at a continuous flow rate.

7. The process of claim 1 wherein the concentration of the precursor solution is in a range of 0.1 to 5 mM.

8. The process of claim 1 wherein the pH of the precursor solution is in a range of 9 to 11.

9. The process of claim 1 wherein the reacting is carried out under at least one of the following conditions: in the dark, at ambient temperature, and undisturbed for up to 14 hrs.

10. The process of claim 1 wherein during the reacting step, a reaction product α-tocopherol quinone (VEq) is formed on the substrate.

11. The process of claim 10 wherein the VEq is then dissolved in EtOH or other organic solvents and is carried away towards an outlet of the chamber, leaving the nanostructures formed on the substrate.

12. The process of claim 1 wherein SERS substrates are produced in batches of at least 100 per run.

13. A surface-enhanced Raman spectroscopy (SERS) comprising:
a substrate; and
a plurality of ordered nanostructures arranged on the substrate.

14. The SERS of claim 13 having a reproducibility as demonstrated by the SERS having a minimum relative standard deviation (RSD) of 3.2%-4.3%.

15. The SERS of claim 13 wherein the plurality of ordered nanostructures are at least one of evenly distributed on the substrate, formed by nanodroplets, and metallic.

16. The SERS of claim 13 wherein the substrate is a micro-patterned substrate.

17. The SERS of claim 13 wherein the micropatterns on the substrate are hydrophobic, and are smooth or physical microdomains.

18. The SERS of claim 13 wherein the substrate is silicon, glass, PDMS, PDMS with microstructures.

19. The SERS of claim 18 wherein the substrate is the PDMS, and the PDMS has a thickness of 2 micrometers to 700 micrometers, and is optionally formed as a film or molded in a shape.

20. The SERS of claim 19 wherein the PDMS is transparent and flexible.

21. (canceled)
